(19) United States
(12) Patent Application Publication
(10) Pub. No.: US 2008/0120154 A1
(43) Pub. Date: May 22, 2008

(54) SYSTEM AND METHOD FOR ADVERTISEMENT GENERATION

(76) Inventor: DANIELLE F. DELLOVO, North Andover, MA (US)

Correspondence Address: CHADBOURNE & PARKE LLP, 30 ROCKEFELLER PLAZA, NEW YORK, NY, 10112, US

(21) Appl. No.: 11/748,448

(22) Filed: May 14, 2007

Related U.S. Application Data
(60) Provisional application No. 60/747,176, filed on May 12, 2006.
(60) Provisional application No. 60/747,405, filed on May 16, 2006.
(60) Provisional application No. 60/824,888, filed on Sep. 7, 2006.

(51) Int. Cl. G06Q 30/00; G06Q 10/00

(52) U.S. Cl. 705/7; 705/14

(57) ABSTRACT

The application discloses apparatuses, systems and methods for providing the generation, serving and distribution of advertisements. Specifically, the disclosed system is particularly suited for the efficient generation and distribution of ads representing narrow offers that are typically advertised using classified ads. Various implementations described herein, discuss generating an advertisement from an advertisement sponsor's base data entry. The base data entry is processed in order to extract terms used to populate the advertisements. The terms may be selected by a user interacting with an advertisement generation interface module or the terms may be extracted by a system-driven extraction process. The extracted data is used to populate an advertisement template generated by the system based on content and format constraints associated with an advertisement request. The system receives the advertisement request from a content provider who wants to incorporate a system generated advertisement along with their distributed content.

### PRIORITY CLAIMS AND RELATED APPLICATIONS

This disclosure claims priority to under 35 U.S.C. § 119 and incorporates by reference U.S. Provisional Patent Application Ser. No. 60/747,176, titled “Job Advertising Generation and Network for Distributing the Same,” filed May 12, 2006, Ser. No. 60/747,405, titled “Job Distribution Network,” filed May 16, 2006, and Ser. No. 60/824,888, titled “System and Method for Advertisement Generation, Selection and Distribution,” filed Sep. 7, 2006. The disclosure also incorporates pending, related non-provisional applications titled “Systems, Methods and Apparatuses for Advertisement Generation, Selection and Distribution System Registration,” filed May 14, 2007, as Ser. No. ______; “Systems, Methods, and Apparatuses for Advertisement Targeting/Distribution,” filed May 14, 2007 as Ser. No. ______; and “Systems, Methods and Apparatuses for Advertisement Evolution,” filed May, 14, 2007, Ser. No. ______, which are all incorporated herein by reference.

### FIELD OF THE INVENTION

The present invention is generally directed to apparatuses, methods and systems for managing advertising. More specifically, the present invention is related to apparatuses, systems and methods for the generating online advertising.

### BACKGROUND OF THE INVENTION

Advertisements offering goods, services, or opportunities can generally be split into two groups depending on whether the offers are narrow or broad. Broad offers that are applicable to a relatively large number of recipients, generally utilize print, radio, television and online advertising techniques that push the advertisement out to a large audience.

On the other hand, narrow offers that are limited in scope, either because they are only relevant to a small target audience or because there are only a few offers available, tend to use advertising mechanisms that rely on the audience finding the advertisement. Classified ads are one example of this limited class of offers. The classifieds rely on readers to search through the ads and look for offers that might be relevant to them. The need for the audience to seek out relevant offers is not ideal.

Online advertising contains mechanisms for advertising both broad and narrow types of offers. Broad offers online are embodied, for example, by banner ads, interstitial, pop-ups and pop-unders. Narrow offers, on the other hand, are generally offered on classified sites, auction sites, job board sites, real estate sites, etc.

There are significant challenges for creating advertisements based on data entries listing offers from classified sites auction sites, job board sites, or real estate sites. For example, one such issue involves maximizing the efficacy and/or relevance of an advertisement distributed across the advertisement. Very few advertisers will pursue online advertisement opportunities unless there is a reasonable likelihood that a web user would be attracted to their advertisement.

### SUMMARY OF THE INVENTION

In view of the foregoing, the present invention provides systems, methods and apparatuses for generating and distributing advertisements. More specifically, embodiments of the system are particularly suited for addressing issues that arise in generating advertisements that attract the attention of web users, even if the advertisements represent narrow listing offers that are typically advertised using classified ads.

In accordance with one aspect of the present invention systems, methods and apparatus are disclosed for creating advertisements from narrow listing offers (e.g., base data entries). The process involves retrieving a structured listing proposing an offer containing listing criteria comprising a title, a category, offer terms and/or a description. The listing is parsed to extract one or more listing criteria. One or more of the parsed listing criteria are selected for inclusion in an advertisement. The system is configured to generate an advertisement from the selected listing criteria.

In accordance with an aspect of an embodiment of the system, the advertisements are generated when a targeting request is received by the system. The targeting request may include parameters detailing an advertisement formatting parameters, as well as requested advertisement content. One or more viewer characteristics associated with current web viewer may be received. A listing database is searched for base data entries that are compatible with received viewer characteristics. Available job advertisements are searched for characteristics matching the viewer's recorded characteristics. Each job advertisement has an associated ad purchase criteria that specifies the ad cost relative to number of viewer criteria matched.

In accordance with another aspect of the present invention, systems, methods and apparatuses are disclosed for optimizing online advertisements. A plurality of different online advertisements directed to a particular offer are generated using different groups of advertisement generation rules. Depending on the system implementation, the advertisement generation rules may be user selected or system default generation rules. Advantageously, the system default rules may be developed and continually refined by analyzing tracking generation characteristics and advertisement performance characteristics. The advertisements performance characteristics may be tracked by the system or may be derived from a user feedback mechanism.

A mechanism may be incorporated into the advertisement, a generated landing page or a user pop-up/under that is provided for viewers to indicate their interest in the offer presented in the advertisement. In an embodiment, a user survey may request feedback for several advertisements generated from the same base data entry. For each of the different online advertisements displayed, performance characteristics associated with viewer interest are recorded. The viewer interest performance characteristics for each of the different online advertisements are then compared. The online advertisements having relatively more indications of viewer interest are selected for further distribution and display. Furthermore, the advertisement generation rule set, for these advertisements are graded as having better performance and may supplant previous system default generation rules.

### BRIEF DESCRIPTION OF THE DRAWINGS

The accompanying appendices and/or drawings illustrate various non-limiting, representative, inventive aspects in accordance with the present disclosure:

FIG. 1 is a diagram illustrating the entities that interact with the system, according to an embodiment of the system.

FIG. 2 is an overview flow diagram illustrating aspects of the advertisement generation process, according to an embodiment of the system.

FIGS. 3A-3E illustrate a flow diagram of the advertisement template retrieval process, as well as examples of advertisement templates, according to an embodiment of the system.

FIG. 4A illustrates a flow diagram of the base data entry data extraction process according to an embodiment of the system.

FIG. 4B illustrates an example of a base data entry according to an embodiment of the system.

FIG. 4C illustrates examples of generated advertisements, according to an embodiment of the system.

FIG. 5A is a flow diagram illustrating aspects of the landing page generation process, according to another embodiment of the system.

FIG. 5B illustrates an example of a landing page generated by an embodiment of the system

FIG. 6 is an ad creation management dashboard, according an embodiment of the system.

FIG. 7 illustrates an embodiment of a CAN advertisement generation controller in accordance with an embodiment of the disclosed system.

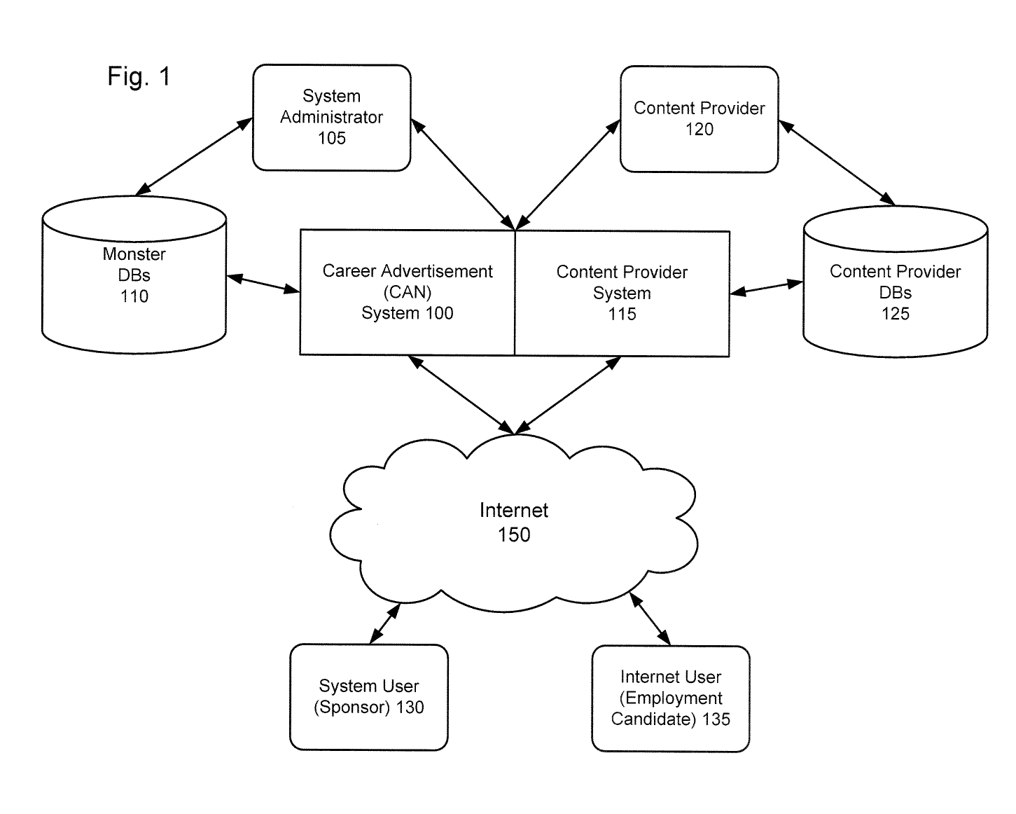

The leading number of each reference numeral indicates the first drawing in which that reference numeral is introduced. For example, content provider database (DB) 125 is first introduced in FIG. 1.

### DETAILED DESCRIPTION

The present disclosure includes a discussion of systems, methods, and apparatuses for generating, managing and distributing advertisements. The disclosed system may be configured to generate advertisements based on a system user's (sponsor's) one or more or narrow listing offers (base data entries), where traditional passive advertising would be ineffective. The disclosed examples are discussed in the context of job placement advertisements, which may be considered as narrow listing offers because they generally are only relevant to a small audience of qualified applicants. Furthermore, job placement advertisements are usually directed to attracting applicants for a limited pool of available positions. It is to be understood that while the system is described in the context of job placement advertisements, the system provides an administrator with significant flexibility and freedom to configure the system for any other number of narrow listing offer or advertisement applications, such as classified product listings including automobiles, personals, real estate, etc.

### Overview

FIG. 1 provides an overview of various entities that may interact with the system at various points during system utilization. According to an embodiment of the invention, the Career Advertisement Network (“CAN”) 100 is a central element in the system facilitating the functionality described herein. A system user (e.g., Employer or base data entry sponsor) 105 connects with the CAN 100 over the internet 110 to either create a new advertising campaign or manage an existing advertising campaign. According to an embodiment, the advertisements created and distributed by the CAN 100 are based on corresponding narrow listings, configured in this example as employment opportunity listings stored within an job listing web site's job listing database (DB) 115.

The system user 105 uses the CAN 100 to create advertisements based on selected job listings stored within the job listing DB 115. Advantageously, the CAN 100 incorporates a flexible system user interface, wherein a system user 105 may determine how much interaction/input they wish to have in the advertisement creation process. Depending on the needs of a particular user, most of functionality associated with the CAN 100 can be implemented based on automated system processes. Alternately, some system functionality may be may configured so that a system user 105 can work with a system administrator 120 or an interactive system module to create/manage an advertisement campaign.

As illustrated in FIG. 1, the CAN 100 coordinates creating and distributing advertisements with content provider system 125. In an embodiment, the content provider system 125 creates and distributes online content from the content provider databases 135 or other sources. The CAN system creates and distributes advertisements that are incorporated into the content as it is presented to the a web user 140. Generally, the content provider may be configured as a web site that provides a web user 140 with online content such as news, entertainment, sports, online media or other types of online content. Furthermore, depending on the actual implementation, the content provider may be an affiliate web site, a partner web site or even hired as an advertisement placement provider.

For example, the content provider 130 may be configured as a sports news web site. The content provider 120 distributes various sports news content from the content provider's database 135. The CAN 100 may be configured to coordinate incorporating CAN generated advertisements into the content distributed by the content provider's system 125. The CAN 100 is configured to create the advertisement based on a variety of factors, some of which may include: a content provider's content, a content provider's advertisement system configuration, web user 140 characteristics, and/or any variety of other distribution metrics established by the system user 105 or system administrator 120. In some embodiments, the CAN 100 is configured with an advertisement tracking module configured to track and record data associated with a web user's interaction with the displayed advertisement.

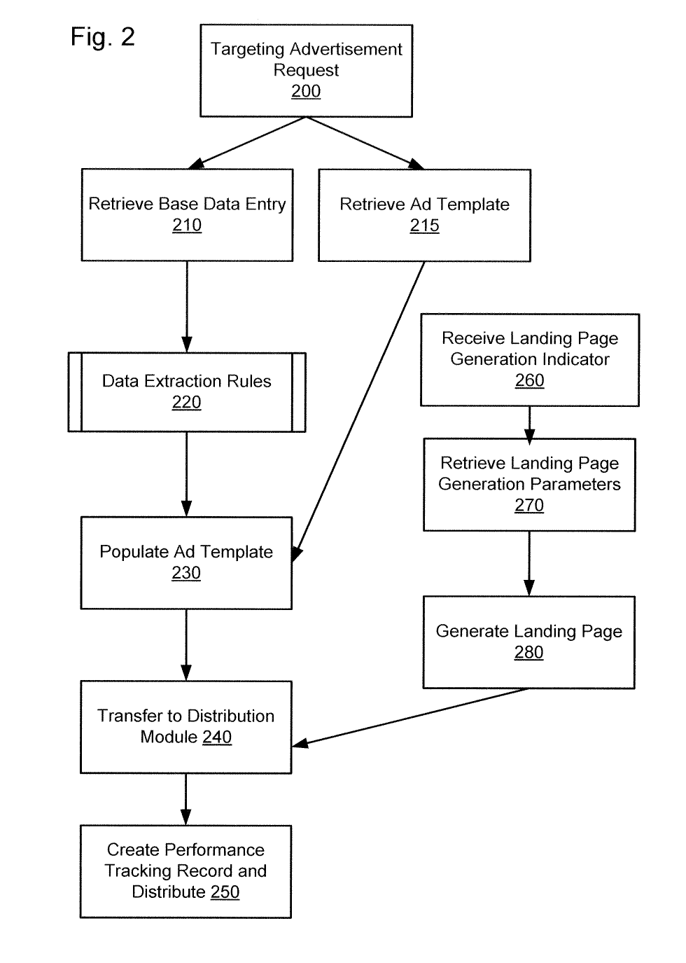

FIG. 2 is a high-level flow diagram illustrating aspects of the advertisement generation process. The system receives an advertisement from content provider/affiliate web site. The advertisement request may specify a variety of advertisement distribution parameters. The advertisement targeting/distribution process is discussed in greater detail in co-pending related application, titled, “Systems, Methods and Apparatuses for Advertisement Targeting/Distribution”, filed May 14, 2007 Ser. No. ______. However, there are two aspects of the targeting/distribution process that are used during the generation process—content advertisement formatting parameters and the actual content associated with the content provider requesting the advertisement.

The system receives the advertisement request from the targeting/distribution module in step 200 and the system extracts these parameters from the request. Based on the request content provider parameters, the system retrieves a base data entry 210 (e.g. If the content provider is a computer engineering news web site, the system may select base data entries directed to software engineering jobs). Further, the system retrieves an advertisement template 215 based content provider's advertisement request parameters detailing the format parameters associated with the requested advertisement. In step 220, the system processes the base data entry in accordance with the data extraction rules. As will be described in greater detail below, this process may be driven by a user interacting with a system advertisement generation module or the process may be automated.

The extracted base data entry parameters are used in step 230 to populate the retrieved advertisement template from step 215. After populating the template, the generated advertisement is transferred to the system distribution module in step 240. Before it is actually distributed to the content provider, the system generates an advertisement tracking record in step 250. As such, the system can maintain a record of performance metrics that detail a web user's interaction with the distributed advertisement.

FIG. 2 also discusses aspects of a landing page generation process, according to an embodiment of the system. Once the advertisement has been distributed to the content provider in step 250, the system may receive web user interaction data or a landing page generation indicator in step 260. When a web user clicks on a distributed advertisement, the advertisement transmits a landing page generation indicator back to the system indicating that the web user wants additional information about the advertised employment opportunity. The system retrieves landing generation parameters associated with the base data entry in step 270.

Depending on the particular implementation, the generated landing page may be the base data entry or the base data entry incorporated into a landing generation template. In step 280, the system retrieves the base data entry and a corresponding landing template, which is populated with the information from the base data entry. The template may also incorporate additional functionality associated with the host entity associated with the base data entry. For example, in the employment opportunity context, the landing page may be configured with resume building functionality or an application submission module.

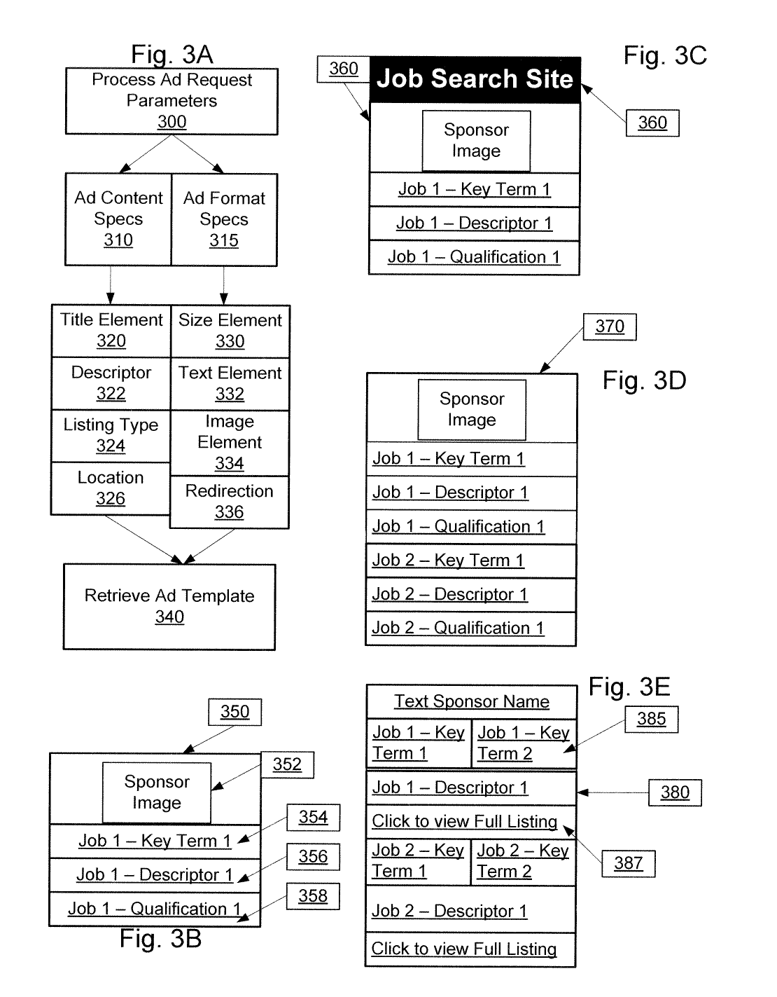

FIG. 3A illustrates a flow diagram illustrating aspects of the advertisement retrieval process. In step 300, the system receives the ad request parameters from the content provider. There are two primary elements that comprise the ad request parameters—ad content parameters 310 and ad formatting parameters 320. The base data entry selected for distribution is selected based on the type of content associated with the advertisement request (e.g., a computer software evaluation content provider will likely be matched with a computer related base data entry). Also included in the advertisement request are the advertisement formatting specifications that detail the advertisement requirements associated with a requested advertisement.

The request parameters detail factors including whether an advertisement template should include a title element 320, a descriptive element 322, a job type element 324, a job location element 326, advertisement size constraints 330, advertisement text constraints 332, advertisement image constraints 334, web user redirection link constraints 336. Based on these advertisement request parameters, the system determines what type of template to retrieve in step 340.

FIG. 3B-3E illustrate several examples of advertisement templates that may be implemented by the system. The templates may be organized based on a variety of template element characteristics. For example, FIGS. 3B-3E may be grouped into two main categories: 1. by the number advertisements associated with a template and/or 2. whether the template is based solely on textual data or a combination of image and textual data. FIG. 3B illustrates a premium template 350 configured for displaying single advertisement. It may be configured to display an advertisement sponsor's image 352, as well as Key Term 354 (selected to attract the attention of a web user), Job Description element 356 (often a brief overview to provide a web user some additional detail beyond the key term), and Job Qualification element 358 (including a base job requirement helps ensure that only qualified applicants pursue the advertisement).

FIG. 3C illustrates a premium template with an additional data host element incorporated into the template. Web users may be more likely to pursue an advertisement, if they know it is hosted by a reputable data entry host. As illustrated, template 360 includes a data host element with the Monster.com host brand 365. The advertisement confidence effect may be even more significant with widely recognized data hosts. Furthermore, the effect may also increase advertisement click-throughs with web users who have already registered with the data host.

FIG. 3D illustrates a dual base data entry template 370, wherein both advertisements are associated with a single sponsor. This is simply a non-limiting example, multiple advertisement templates do not necessarily have to be associated with the same sponsor. Furthermore, the example 370 may be configured to incorporate additional advertisements. FIG. 3E illustrates a text-based template 380. Also, the template 380 is configured with dual key terms 385, as well as a user redirection element 387 (although the other templates do not explicitly illustrate the redirection element, it is to be understood that the key terms or another template element may be configured to effectuate directing a web user to a landing page or the base data entry within the data host if a web user indicates they would like additional information).

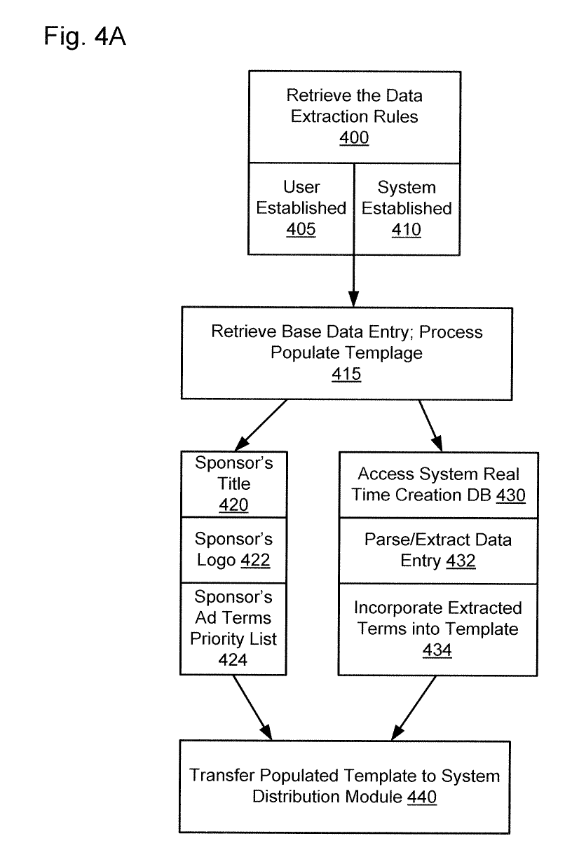

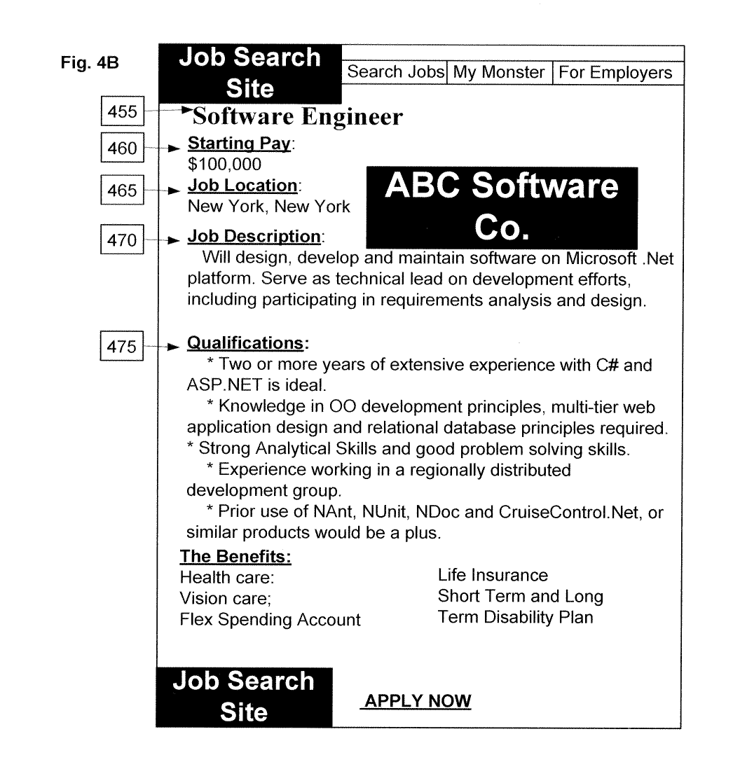

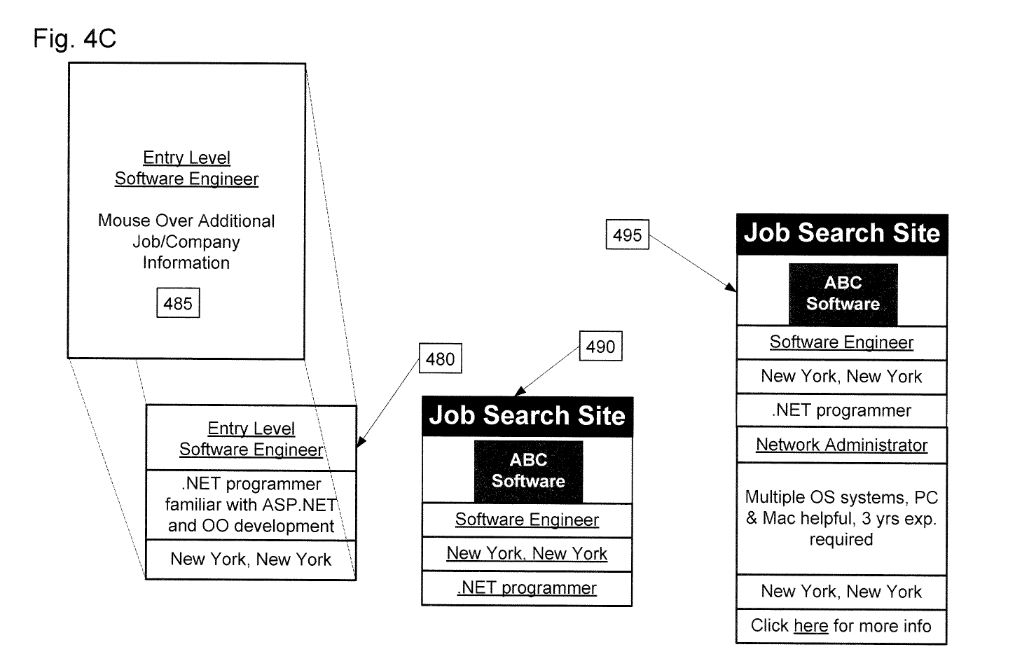

Once the advertisement template has been retrieved, the system retrieves and processes the base data entry. FIG. 4A illustrates aspects of the base data entry parameter extraction process. The system retrieves the data extraction rules that are associated with the selected base data entry in step 400. The data extraction rules detail the parsing process for deriving the elements used to populate the retrieved advertisement template. Depending on the implementation, the extraction rules may be established by the user 405, based a set of system established extraction rules 410, or a user-selected variant of the system established rules. The user (advertisement sponsor) may interact with the system to create an example advertisement, that the system will recreate when an advertisement request selects that sponsor's base data entry for distribution as an advertisement.

Alternately, the sponsor may simply correlate base data entry elements with template elements. For example, in a sponsor-driven advertisement generation process, the system may be configured with a user-friendly advertisement creation module. In one implementation, the sponsor may be presented with an interactive image of the base data entry next to the advertisement template. In this embodiment, the sponsor may click, drop and drag base data entry elements into the corresponding element fields in the advertisement template.

As illustrated in FIG. 4B, the sponsor may click and drag a “job title” 455 element into the “key term” template field. The sponsor may select or modify base data entry elements. If the sponsor wants to establish a “qualification” element field in a template, the sponsor may select the whole qualification element from the base data entry. Alternately, the sponsor may be provided with an editing interface and given the opportunity to edit the element before incorporating it into the template. As illustrated in FIG. 4A, the sponsor may establish the advertisement title 420, the advertisement logo 422, and select the additional terms for incorporation into the template 424. In an implementation, the sponsor may designate base data entry elements for incorporation into the advertisement based on available space (i.e., the sponsor can rank whether they want to include a salary element 460 before a job location element 465 based on size/character constraints associated with a particular template).

The system may also be configured to implement an system driven extraction rule set. The system driven rule set is configured as an input into an automated base data entry element extraction process. Advantageously, the system may record and correlate different sets of generation rules with performance and efficacy metrics.

However, with significant resources to draw upon, the system driven generation rule set may provide a higher level of advertisement efficacy. In step 430, the system retrieves a system default generation rule set selected for the particular base data entry. In step 432, the system parses the base data entry and extracts the data elements according to the rule set. For example, the system generation rule set may be configured to extract a job title 455, starting salary 460, and two qualification requirements 475 from the base data entry illustrated in FIG. 4B. In step 434, the system uses the extracted elements to populate the advertisement template. The populated template is transferred to an advertisement distribution module, in step 440.

FIG. 4C illustrates several examples of populated advertisement templates. Advertisement 480 is an example of a text-based advertisement with a job title incorporated as a key term. The advertisement also includes a brief description element and a job location element. The advertisement 480 also incorporates a mouse-over resource element 485. When a web user moves the mouse pointer over the advertisement, the distributed advertisement spawns another pop-up window displaying additional job information or information about the advertisement sponsor. As such, the web user is able to ascertain additional detail about the distributed advertisement without leaving the initial advertisement display web page. Advertisement 490 incorporates both a host data entity element (e.g., Monster.com), as well as an image-based advertisement into the base advertisement template.

Example advertisement 495 illustrates a multiple advertisement, single sponsor implementation. More specifically, advertisement 495 includes two sub-advertisements: one for a software engineer and one for a network administrator. Also, the advertisement 495 includes a host data entity element and a separate redirection element. Certain sponsors may be interested in using the independent redirection element in order to redirect a web user to additional base data entries that they sponsor not included in the distributed advertisement.

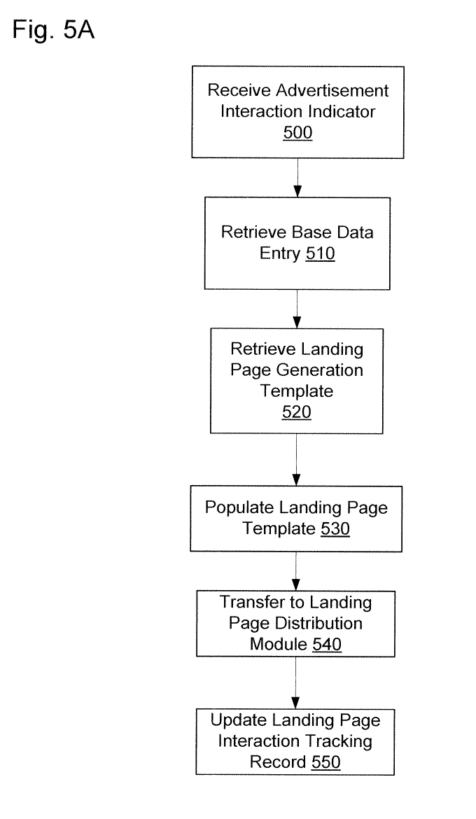

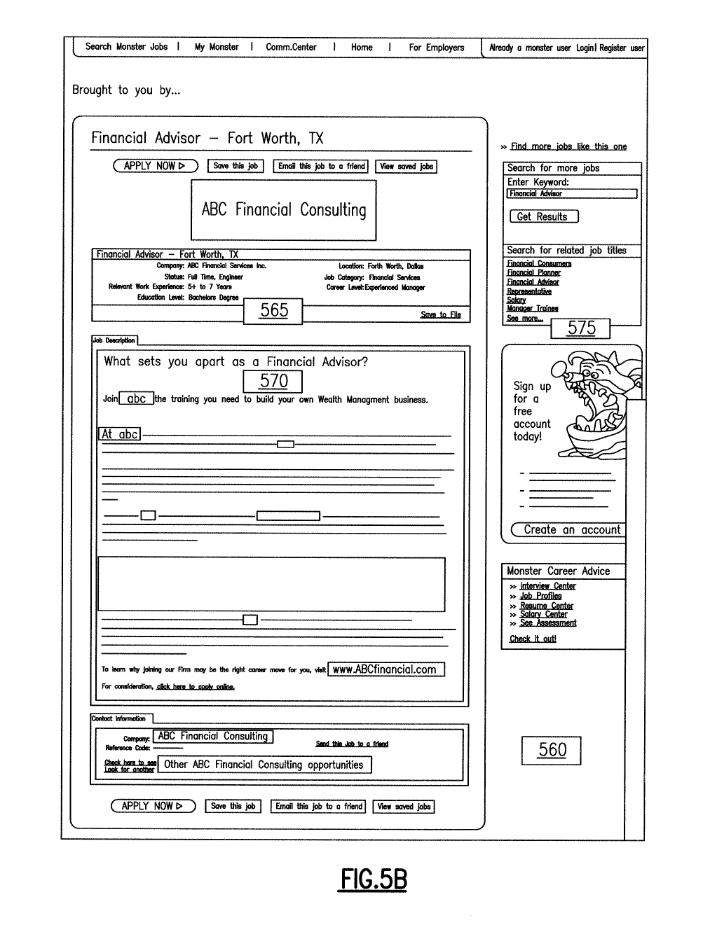

FIG. 5A illustrates aspects of a landing page generation process. The system generates a landing page (landing page), when a web user clicks on a distributed advertisement, thereby indicating they would like additional information about the opportunity. In step 500, the system receives an advertisement interaction indicator. This is generated and transmitted by the distributed advertisement and effectively signals the system to send additional information about the advertised good, service or opportunity. Upon receipt of the indicator in step 500, the system identifies the base data entry corresponding to the distributed advertisement in step 510.

This type of advertisement is also extremely useful in the context of the advertisement evolution data analysis process. Two advertisements may be created using different generation rule sets based on the same base data entry. Advantageously, the system may track and analyze the distributed advertisements' respective performance based on being displayed to the same web user, in the same content context.

The system processes the record entry associated with the base data entry to determine if a landing page generation template has been selected by a user. If a template has been selected, the system retrieves the template, otherwise the system implements a system-default landing generation template in step 520. The system then populates the landing page template with data from the base data entry in accordance with sponsor designated landing page generation rules. This process is similar to the advertisement template population process described above (e.g., it may be user-driven or system driven).

In step 540, the populated landing page is transferred to a distribution module for transmission back to the same web user IP address as the distributed advertisement. In some implementations, the destination information is included in the interaction indicator and consequently step 540 may be omitted. In step 550, the system creates a landing page interaction tracking record. This is used by the system to analyze the efficacy of distributed landing pages and derive performance metrics. The distributed landing page may also transmit web user interaction data back to the system as part of this analysis.

There are a variety of templates available depending on the sponsor's needs. The templates may be configured to provide a copy of the base data entry as the landing page. Alternately, a premium template may incorporate the base data entry into a distributed page that also includes base data entry or data host entity related functionality. An example of the premium template 560 is illustrated in FIG. 5B within the job application context. As shown, landing page 560 incorporates data from the base data entry 565, but it also may incorporate sponsor information 570 and/or information or functionality associated with the base data entry host entity 575 (e.g., searching for similar jobs on Monster.com).

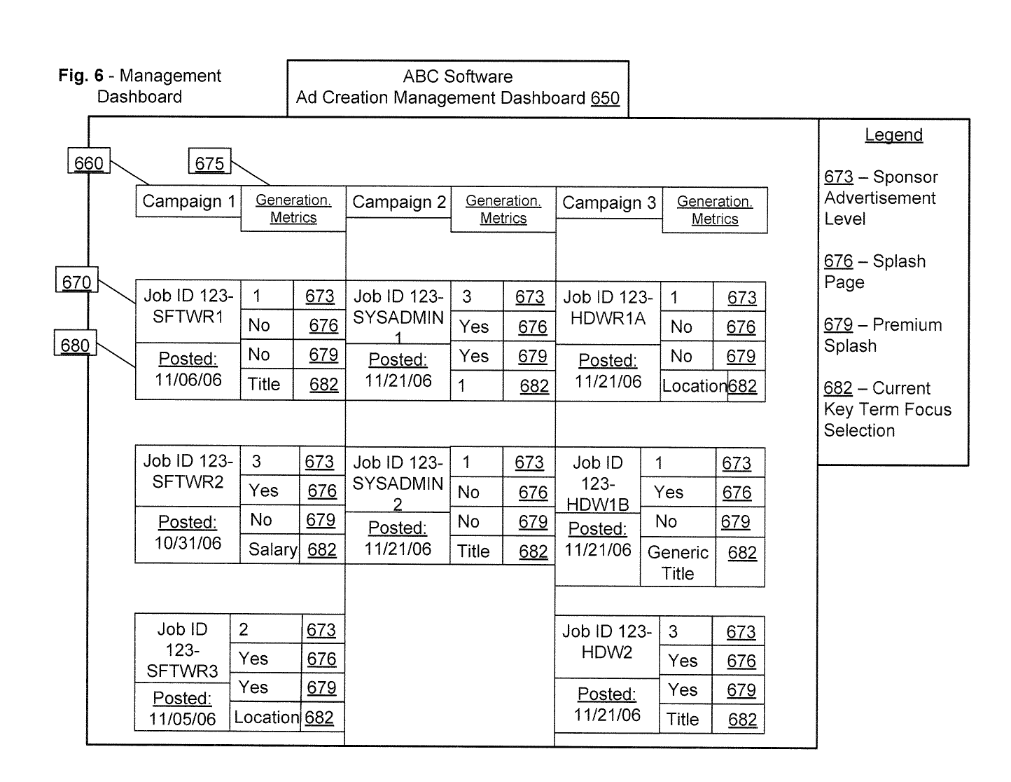

FIG. 6 illustrates a sponsor management dashboard 650 that a sponsor may user to manage various aspects of the advertisement generation process. The management dashboard is an effective tool to help a sponsor coordinate and keep track of advertisement campaigns 660, 663, and 666. The dashboard may be configured to display an advertisement ID 670, and the date it was distributed 680 or created. As illustrated in the FIG. 6, the dashboard displays generation metrics associated with the advertisements 675.

In the implementation illustrated in FIG. 6, the generation metrics include a sponsor advertisement level 673 (which may be configured as scaled number indicating the user determined type of template/content associated with the advertisement). In this implementation, the dash board also indicates whether a landing page 676 has been associated with the advertisement, as well as whether the landing page includes premium functionality 679. The sponsor is also able to see what the current key term element is from the base data entry 682 (e.g., whether the advertisement will emphasize a job title, salary, location or other element as the advertisement key word).

### Advertisement Generation and Serving Controller

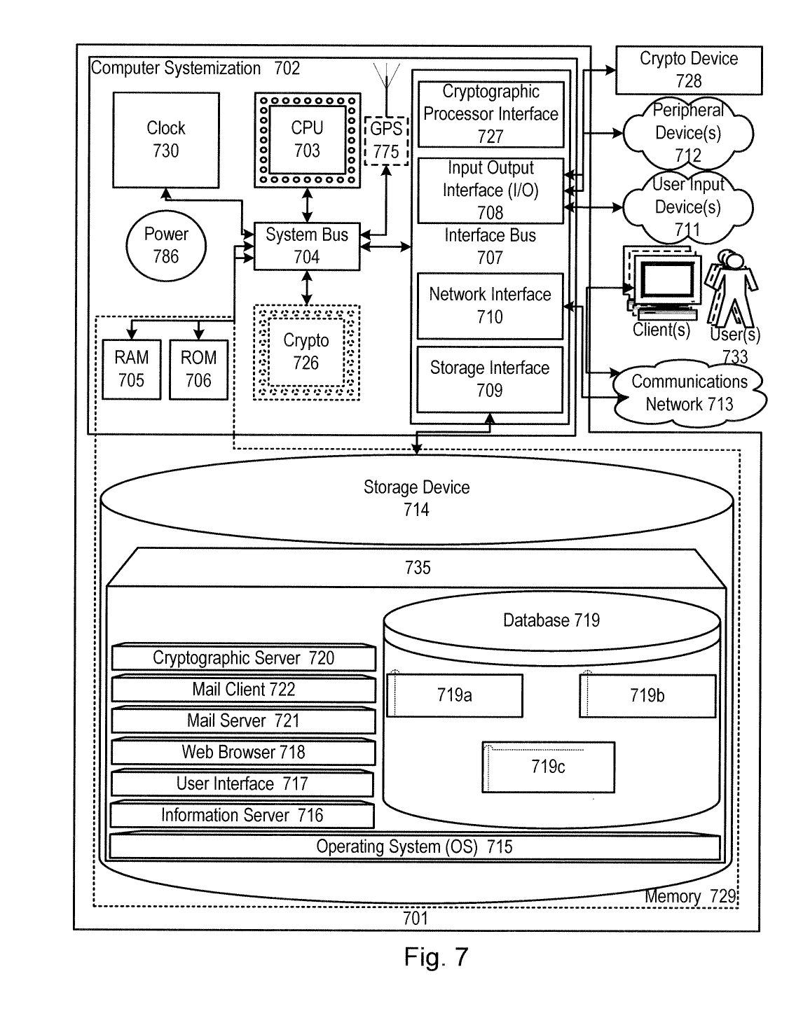

The advertisement server and generators described above can be embodied by an advertisement generation and serving (AGS) controller 701. FIG. 7 of the present disclosure illustrates inventive aspects of the AGS controller 701 in a block diagram. In this embodiment, the AGS controller 701 may serve to generate, manage, price, sell, match, display, serve, and distribute advertisements.

Computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the AGS controller 701 may be connected to and/or communicate with entities such as, but not limited to: one or more users from user input devices 711; peripheral devices 712; a cryptographic processor device 728; and/or a communications network 713.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The AGS controller 701 may be based on common computer systems that may comprise, but are not limited to, components such as: a computer systemization 702 connected to memory 729.

Computer Systemization

A computer systemization 702 may comprise a clock 730, central processing unit (CPU) 703, a read only memory (ROM) 706, a random access memory (RAM) 705, and/or an interface bus 707, and most frequently, although not necessarily, are all interconnected and/or communicating through a system bus 704. Optionally, the computer systemization may be connected to an internal power source 786. Optionally, a cryptographic processor 726 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the AGS controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 786 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the AGS thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the AGS controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 711 may be card readers, dongles, finger print readers, gloves, graphics tablets, joysticks, keyboards, mouse (mice), remote controls, retina readers, trackballs, trackpads, and/or the like.

Peripheral devices 712 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the AGS controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the AGS controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 740 MHz Roadrunner.

Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the AGS controller and/or a computer systemization may employ various forms of memory 729. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 729 will include ROM 06, RAM 05, and a storage device 714. A storage device 714 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 729 may contain a collection of program and/or database modules and/or data such as, but not limited to: operating system module(s) 715 (operating system); information server module(s) 716 (information server); user interface module(s) 717 (user interface); Web browser module(s) 718 (Web browser); database(s) 719; cryptographic server module(s) 720 (cryptographic server); the AGS module(s) 735; and/or the like (i.e., collectively a module collection). These modules may be stored and accessed from the storage devices and/or from storage devices accessible through an interface bus. Although non-conventional software modules such as those in the module collection, typically, are stored in a local storage device 714, they may also be loaded and/or stored in memory such as: peripheral devices, RAM, remote storage facilities through a communications network, ROM, various forms of memory, and/or the like.

Operating System

The operating system module 715 is executable program code facilitating the operation of the AGS controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the AGS controller to communicate with other entities through a communications network 713. Various communication protocols may be used by the AGS controller as a subcarrier transport mechanism for interaction, such as, but not limited to: multicast, TCP/IP, UDP, unicast, and/or the like.

Information Server

An information server module 16 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the AGS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “/myInformation.htmil.” Additionally, other information serving protocols may be employed across various ports, e.g., FTP communications across port 721, and/or the like. An information server may communicate to and/or with other modules in a module collection, including itself, and/or facilities of the like. Most frequently, the information server communicates with the AGS database 19, operating systems, other program modules, user interfaces, Web browsers, and/or the like.

Access to the AGS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the AGS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the AGS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 717 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 718 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the AGS enabled nodes. The combined application may be nugatory on systems employing standard Web browsers.

Cryptographic Server

A cryptographic server module 720 is stored program code that is executed by the CPU 703, cryptographic processor 726, cryptographic processor interface 727, cryptographic processor device 728, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the AGS may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable the AGS module to engage in secure transactions if so desired. The cryptographic module facilitates the secure accessing of resources on the AGS and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

The AGS Database

The AGS database module 719 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the AGS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the AGS database is implemented as a data-structure, the use of the AGS database 719 may be integrated into another module such as the AGS module 735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 719 includes several tables 19a-c. A base data entry table 719a includes fields such as, but not limited to: sponsor ID, preferred content IDs, related base data entries, and/or the like. A generation rule set table 719b includes fields such as, but not limited to: parsing priority, key term elements, location element, salary element, opportunity type element, and/or the like. An landing page table 719c includes fields such as, but not limited to: base data entry, redacted base data entry, sponsor information, host data entity, additional landing functionality, and/or the like.

In one embodiment, the AGS database may interact with other database systems. For example, employing a distributed database system, queries and data access by the AGS modules may treat the combination of the AGS and AGS database as a single database entity. It should be noted that an AGS version of the AGS database might not have an employer account table and/or other tables specific to an AGS database.

In one embodiment, user programs may contain various user interface primitives, which may serve to update the AGS. Also, various accounts may require custom database tables depending upon the environments and the types of clients the AGS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database modules 719a-c. The AGS may be configured to keep track of various settings, inputs, and parameters via databases controllers.

The AGS database may communicate to and/or with other modules in a module collection, including itself, and/or facilities of the like. Most frequently, the AGS database communicates with the AGS module, other program modules, and/or the like. The database may contain, retain, and provide information regarding other nodes and data.

The AGS

The AGS module 735 is stored program code that is executed by the CPU. The AGS affects accessing, obtaining and the provision of information, services, transactions, and/or the like across various communications networks.

The AGS module enables generation of transactions for investors to contribute to such various asset funds and achieve investment fund optimizations for such exchanges.

The AGS module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the AGS server employs a cryptographic server to encrypt and decrypt communications. The AGS module may communicate to and/or with other modules in a module collection, including itself, and/or facilities of the like. Most frequently, the AGS module communicates with the AGS database, operating systems, other program modules, and/or the like. The AGS may contain, communicate, generate, obtain, and/or provide program module, system, user, and/or data communications, requests, and/or responses.

Distributed AGS

The structure and/or operation of any of the AGS node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the AGS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method for generating online advertisements comprising:
receiving an advertisement generation request;
retrieving a base data entry based on parameters included in the advertisement generation request;
retrieving an advertisement template;
accessing advertisement generation rules;
applying the advertisement generation rules in parsing the base date entry and extracting insertion elements; and
populating the advertisement templates with extracted insertion terms.

2. The method of claim 1, wherein the advertisement generation request includes a content context and advertisement specification parameters.

3. The method claim 2, wherein the base data entry is selected for distribution based on the content context and advertisement specification parameters.

4. The method of claim 3, wherein the advertisement template is selected to conform to the advertisement specification parameters.

5. The method of claim 1, wherein the advertisement generation rule set is established by an advertisement sponsor.

6. The method of claim 1, wherein the advertisements rule set is established as system default generation rules.

7. The method of claim 4, wherein the advertisement template includes user designated advertisement elements that are extracted from the base data entry.

8. The method of claim 7, wherein the advertisement template incorporates an text advertisement element.

9. The method of claim 7, wherein the advertisement template incorporates an image advertisement element.

10. The method of claim 1, wherein the advertisement template incorporates an image display element.

11. The method of claim 7, further comprising:
incorporating a user interaction element into the advertisement.

12. The method of claim 11, wherein the user interaction element spawns a landing page providing additional sponsor or opportunity information.

13. The method of claim 11, wherein the user interaction element transmits an advertisement interaction indicator after the advertisement has been distributed.

14. The method of claim 1, further comprising:
maintaining an advertisement performance tracking record.

15. The method of claim 1, further comprising:
receiving an advertisement interaction indicator retrieving a landing page template;
applying landing page generation rules for populating the landing page template; and
distributing the populated landing page.

16. The method of claim 15, further comprising:
maintaining a landing page performance tracking record.

17. The method of claim 15, further comprising:
incorporating a user interaction element into the landing page.

18. A processor-implemented method for advertisement management comprising:
storing a structured listing in a database;
retrieving an advertisement template corresponding to the structured listing;
parsing the structured listing to extract key terms;
populating the advertisement template based on the extracted key terms to generate an advertisement;
incorporating an interaction tracking element into the advertisement; and
distributing the advertisement to a content provider for incorporation into displayed content.

19. The method of claim 18, further comprising:
generating a corresponding advertisement landing page based on extracted key terms from the parsed structured listing if an interaction indicator is received from a distributed advertisement; and
distributing the landing page upon receipt of a user interaction indicator.

20. The method of claim 18, further comprising:
maintaining a sponsor management dashboard displaying advertisement generation data associated with a sponsor's advertisements.

21. A system for generating online advertisements comprising:
a memory;
a processor disposed in communication with said memory, and configured to issue a plurality of processing instructions stored in the memory, wherein the instructions issue signals to:
receive an advertisement generation request;
retrieve a base data entry based on parameters included in the advertisement generation request;
retrieve an advertisement template;
access advertisement generation rules;
apply the advertisement generation rules in parsing the base date entry and extracting insertion elements; and
populate the advertisement templates with extracted insertion terms.

22. The system of claim 21, wherein the advertisement generation request includes a content context and advertisement specification parameters.

23. The system claim 22, wherein the base data entry is selected for distribution based on the content context and advertisement specification parameters.

24. The system of claim 23, wherein the advertisement template is selected to conform to the advertisement specification parameters.

25. The system of claim 21, wherein the advertisement generation rule set is established by an advertisement sponsor.

26. The system of claim 21, wherein the advertisements rule set is established as system default generation rules.

27. The system of claim 24, wherein the advertisement template includes user designated advertisement elements that are extracted from the base data entry.

28. The system of claim 27, wherein the advertisement template incorporates a text advertisement element.

29. The system of claim 27, wherein the advertisement template incorporates an image advertisement element.

30. The system of claim 21, wherein the advertisement template incorporates an image display element.

31. The system of claim 27, further comprising instructions configured for:
incorporating a user interaction element into the advertisement.

32. The system of claim 31, wherein the user interaction element spawns a landing page providing additional sponsor or opportunity information.

33. The system of claim 31, wherein the user interaction element transmits an advertisement interaction indicator after the advertisement has been distributed.

34. The system of claim 21, further comprising instructions configured to:
maintain an advertisement performance tracking record.

35. The system of claim 21, further comprising instructions configured to:
receive an advertisement interaction indicator
retrieve a landing page template;
apply landing page generation rules for populating the landing page template; and
distribute the populated landing page.

36. The system of claim 35, further comprising instructions configured to:
maintain a landing page performance tracking record.

37. The system of claim 35, further comprising:
incorporate a user interaction element into the landing page.

38. A system for advertisement management comprising:
a memory;
a processor disposed in communication with said memory, and configured to issue a plurality of processing instructions stored in the memory, wherein the instructions issue signals to:
store a structured listing in a database;
retrieve an advertisement template corresponding to the structured listing;
parse the structured listing to extract key terms;
populate the advertisement template based on the extracted key terms to generate an advertisement;
incorporate an interaction tracking element into the advertisement; and
distribute the advertisement to a content provider for incorporation into displayed content.

39. The system of claim 38, further comprising instructions configured to:
generate a corresponding advertisement landing page based on extracted key terms from the parsed structured listing if an interaction indicator is received from a distributed advertisement; and
distribute the landing page upon receipt of a user interaction indicator.

40. The system of claim 38, further comprising instructions configured to:
maintain a sponsor management dashboard displaying advertisement generation data associated with a sponsor's advertisements.
